(19) United States
(12) Patent Application Publication
(10) Pub. No.: US 2021/0157860 A1
(43) Pub. Date: May 27, 2021

(54) OBJECT RECOMMENDATION METHOD AND APPARATUS, STORAGE MEDIUM AND TERMINAL DEVICE

(71) Applicant: BEIJING BYTEDANCE NETWORK TECHNOLOGY CO., LTD., Beijing (CN)

(72) Inventors: Hang LI, Beijing (CN); Xiaoying ZHANG, Beijing (CN)

(21) Appl. No.: 16/979,583

(22) PCT Filed: Apr. 30, 2019
(86) PCT No.: PCT/CN2019/085363

§ 371 Date: Sep. 10, 2020

(51) Int. Cl. G06F 16/903; G06F 16/9032; G06F 16/9035; G06F 16/9038

(52) U.S. Cl. CPC G06F 16/90344; G06F 16/9038; G06F 16/9035; G06F 16/90332

(57) ABSTRACT

An object recommendation method and apparatus, a storage medium and a terminal device are provided. The method includes: obtaining historical behavior data and historical feedback data of a user; determining a questioning keyword based on the historical behavior data and the historical feedback data; performing a question-and-answer interaction based on the questioning keyword to obtain feedback data; determining a target recommendation object based on the feedback data; and outputting the target recommendation object, so as to implement recommendation. The provided technical solution diversifies the dimensions in prediction of the interest tendency of the user by using the question-and-answer interaction, improves the accuracy and flexibility in recognizing the objects of interest of the user, thereby improving the accuracy and flexibility of recommendation.

### TECHNICAL FIELD

The present disclosure relates to the technical field of computers, and in particular to an object recommendation method, an object recommendation apparatus, a storage medium and a terminal device.

### BACKGROUND

With the popularity of smart terminals and the development of computer technology, online recommendation systems are increasingly involved in the lives of users. The conventional online recommendation system generally recommends an object of interest, such as an item or information, to a user by collecting historical data of the user. That is, when recommending an object such as an item or information for the user, historical data of the user such as transaction data or reading data is collected, the historical data is analyzed and processed to predict another one or more objects that the user may be interested in, and these items or information of interest is pushed to the user.

### SUMMARY

An object recommendation method, an object recommendation apparatus, a storage medium and a terminal device are provided according to one or more embodiments of the present disclosure, to increase the dimensions in prediction of interests of the user and improve the accuracy and flexibility in recognizing the objects of interest of the user, thereby improving the accuracy and flexibility of recommendation.

In a first aspect, an object recommendation method is provided according to one or more embodiments of the present disclosure. The method includes:

obtaining historical behavior data and historical feedback data of a user;

determining a questioning keyword based on the historical behavior data and the historical feedback data;

performing a question-and-answer interaction based on the questioning keyword to obtain feedback data;

determining a target recommendation object based on the feedback data; and

outputting the target recommendation object.

In a second aspect, an object recommendation apparatus is provided according to one or more embodiments of the present disclosure. The apparatus includes an obtaining module, a first determining module, an interacting module, and a second determining module.

The obtaining module is configured to obtain historical behavior data and historical feedback data of a user.

The first determining module is configured to determine a questioning keyword based on the historical behavior data and the historical feedback data.

The interacting module is configured to perform a question-and-answer interaction based on the questioning keyword to obtain feedback data.

The second determining module is configured to determine a target recommendation object based on the feedback data.

The interacting module is further configured to output the target recommendation object.

In a third aspect, an object recommendation apparatus is provided according to one or more embodiments of the present disclosure. The apparatus includes:

a memory;

a processor; and

a computer program.

The computer program is stored in the memory and is configured to be executed by the processor to perform the method according to the first aspect.

In a fourth aspect, a computer-readable storage medium having a computer program stored thereon is provided according to one or more embodiments of the present disclosure.

The computer program is executed by a processor to perform the method according to the first aspect.

In a fifth aspect, a terminal device is provided according to one or more embodiments of the present disclosure. The terminal device includes:

a terminal body; and

an object recommendation apparatus configured to perform the method according to the first aspect.

### BRIEF DESCRIPTION OF THE DRAWINGS

FIG. 1 is a flow chart of an object recommendation method according to the present disclosure;

FIG. 2 is a flow chart of another object recommendation method according to the present disclosure;

FIG. 3 is a flow chart of another object recommendation method according to the present disclosure;

FIG. 4 is a flow chart of another object recommendation method according to of the present disclosure;

FIG. 5 is a flow chart of another object recommendation method according to the present disclosure;

FIG. 6 is a flow chart of another object recommendation method according to one or more embodiments of the present disclosure;

FIG. 7 is a flow chart of another object recommendation method according to the present disclosure;

FIG. 8 is a functional block diagram of an object recommendation apparatus according to the present disclosure;

FIG. 9 is schematic structural diagram of an object recommendation apparatus according to the present disclosure; and

FIG. 10 is a functional block diagram of a terminal device according to the present disclosure.

Through the above drawings, clear one or more embodiments of the present disclosure are shown, which will be described in more detail later. These drawings and text descriptions are not intended to limit the scope of the concept of the present disclosure in any way, but to explain the concept of the present disclosure to those skilled in the art by referring to specific one or more embodiments.

### DETAILED DESCRIPTION

Exemplary one or more embodiments will be described in detail here, examples of which are shown in the drawings. When referring to the drawings below, unless otherwise indicated, the same numerals in different drawings represent the same or similar elements. The one or more embodiments described in the following exemplary one or more embodiments do not represent all one or more embodiments consistent with the present disclosure. Rather, they are merely examples of devices and methods consistent with some aspects of the present disclosure as detailed in the appended claims.

The present disclosure is applicable to a scenario for personalized recommendation for a user, for example, a scenario for recommending products that the user may be interested in, a scenario for recommending other users that the user may be interested in, or a scenario for recommending news or other information that the user may be interested in. As another example, the recommendation object may also be a personalized service that is customized for the user, where the personalized service may include: a personalized travel service, a personalized insurance service, a personalized interface display service (different users have different display interface layouts), and the like.

As mentioned above, taking the above personalized recommendation scenario as an example, the existing method for recognizing an object of interest of the user depends on only historical data of the user, such that the recognition has a single dimension and has a certain delay, resulting in low recognition accuracy and low recommendation accuracy.

The technical solution according to the present disclosure aims to solve the above technical problems of the conventional technology, and a solution is proposed, which includes: performing a human-machine question-and-answer interaction with a user, and obtaining a user interest profile based on the feedback data of the question-and-answer interaction, where the questions used in the question-and-answer interaction may be determined based on the historical behavior data of the user. In this way, the subjective needs and real-time interests of the user are used as an important reference dimension to improve the degree that the possible object of interest of the user matches the actual object of interest of the user, thereby improving the accuracy of recommendation.

The following describes in detail the technical solutions of the present disclosure and how the technical solutions of the present application solve the above technical problems with specific one or more embodiments. The following specific one or more embodiments may be combined with each other, and the same or similar concepts or processes may not be repeated in some embodiments. The one or more embodiments of the present disclosure will be described below with reference to the drawings.

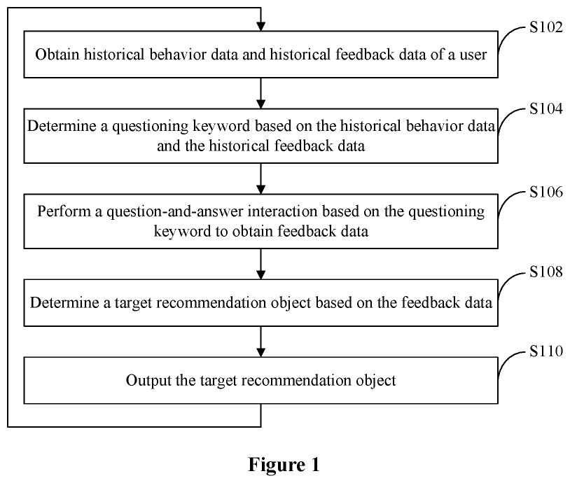

An object recommendation method is provided according to one or more embodiments of the present disclosure. Referring to FIG. 1, the method includes the following steps S102 to S110.

In step S102, historical behavior data and historical feedback data of a user are obtained.

Specifically, the historical behavior data involved in the one or more embodiments of the present disclosure may include, but is not limited to, at least one of the following: historical query behavior data, historical sharing behavior data, historical transaction behavior data, historical collection behavior data, and historical evaluation behavior data.

The historical feedback data is obtained from the object recommended before the currently performed object recommendation method.

In addition, the historical behavior data and the historical feedback data obtained in this step may be all historical behavior data and all historical feedback data of the user. Alternatively, the historical behavior data and the historical feedback data obtained in this step may be historical behavior data and historical feedback data within a period of time, for example, historical behavior data and historical feedback data of the last month or the last 3 days. In addition, the historical behavior data and the historical feedback data obtained in this step may be specific to one or more applications (APP), or may be historical behavior data and historical feedback data of all applications in the terminal device. Further, the historical behavior data and the historical feedback data obtained in this step may be historical behavior data and historical feedback data for a certain type of application or for one or more types of objects in the terminal applications.

For example, the historical behavior data and the historical feedback data of all news apps in the terminal device in the latest month may be obtained. In this case, the historical behavior data may include only the historical query behavior data.

For another example, historical transaction data, historical evaluation data, and historical feedback data of all shopping apps in the terminal device in the latest year may be obtained.

In step S104, a questioning keyword is determined based on the historical behavior data and the historical feedback data.

In the one or more embodiments of the present disclosure, the keyword is associated with an object. In an implementation, the keyword may be an attribute, a category, or a closely related word of an object. In addition, when the keyword is preset, a multi-level classification method may be used.

News objects are taken as an example. For example, the keyword may be “Sports”, “Basketball”, “Well-known basketball player A” and the like, where the news objects associated with “Sports” include the news objects associated with “Basketball”; and “Well-known basketball player A” as a closely related word for basketball news objects, may be associated with basketball news objects, that is, may be associated with the news objects associated with “Basketball” or included in the news objects associated with “Basketball”. The keyword for other types of objects may be preset in a manner similar to the above news objects, and is not described in detail.

A set of the above preset keyword, combined with the historical behavior data of the user may be used for obtaining the questioning keyword. In implementation, the questioning keyword may be K keywords that whether the user is currently interested in is most uncertain (where K is an integer greater than 0), or the questioning keyword may be K keywords that the user is most likely interested in.

The implementation of this step is described in detail later.

In step S106, a question-and-answer interaction is performed based on the questioning keyword to obtain feedback data.

That is, questioning data is outputted based on the questioning keyword that is determined in the previous step, and operation information of the user associated with the questioning data is collected to obtain the feedback data.

For example, if the above determined questioning keyword is “Sports”, the question “Do you like sports?” is outputted in this step. At the same time, virtual buttons for the user to select or operate may be outputted. The feedback data “like” or “dislike” may be obtained based on the collected operation information performed by the user on the virtual button.

In addition, one or more questioning keywords may be determined in the above step S104. Therefore, when step S104 is performed, if there are multiple questioning keywords, multiple rounds of interaction may be performed, or a single round interaction may be performed.

In a possible design, multiple questions (or questioning keywords) may be outputted at the same time, and the questioning keyword selected by the user may be used as the interest keyword. For example, the question “please select the keywords you are interested in” is displayed on the terminal interface, and the above determined multiple keywords is outputted. In this way, the feedback data of the question-and-answer interaction may be obtained when the selection operation of the user for a keyword is collected.

In step S108, a target recommendation object is determined based on the feedback data.

That is, objects are recommended to the user based on the interest keyword fed back by the user. In this way, recommendation accuracy and reliability can be improved.

In step S110, the target recommendation object is outputted.

The above determined target recommendation object is outputted on a display interface of the terminal device for implementing recommendation. The outputting manner is not limited in the present disclosure. For example, in a possible implementation, a target recommendation object with a higher matching degree or a higher evaluation value may be preferentially outputted. In addition, target recommendation objects of different categories may be outputted in sequence or in different regions based on the categories. With the above solution, the interest keyword of the user may be determined through the question-and-answer interaction with the user, which can adapt to the personalized needs of the user, such that the accuracy and flexibility in recognizing the object of interest of the user can be effectively improved, and recommendation accuracy and flexibility can be improved.

It is to be noted that, as shown in FIG. 1 and subsequent drawings, one or more embodiments of the present disclosure further shows the flow from S110 to S102. This is because, in the technical solution according to the one or more embodiments of the present disclosure, after the target recommendation object is outputted and when a next recommendation process is performed, the data of the user associated with the currently outputted target recommendation object may also be obtained as historical recommendation data, and participate in the next recommendation process. This is not repeated in the following.

In the following, in order to facilitate understanding, the implementation of determining the questioning keyword in the above step S104 is described in detail.

As described above, the questioning keyword may be K keywords that whether the user is currently interested in is most uncertain (where K is an integer greater than 0), or the questioning keyword may be K keywords that the user is most likely interested in.

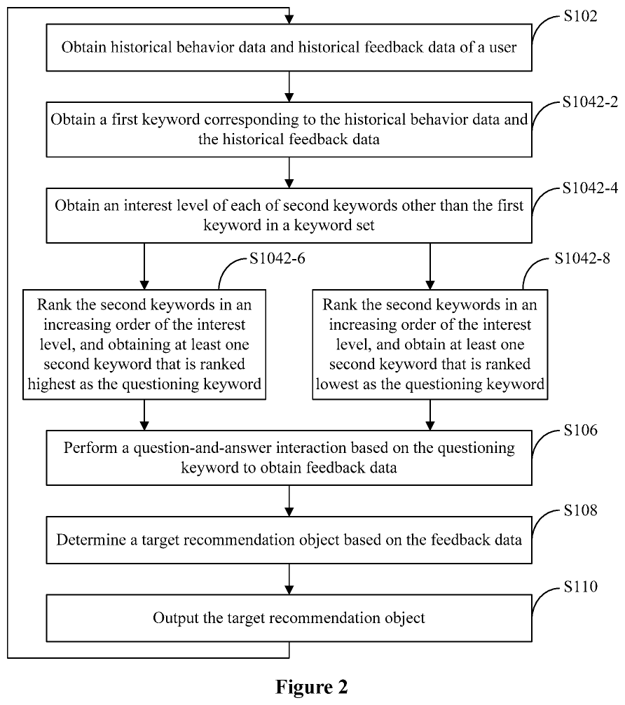

In a possible implementation of step S104, reference may be made to the method shown in FIG. 2, step S104 may be implemented through the following steps S1042-2 to S1042-8.

In step S1042-2, a first keyword corresponding to the historical behavior data and the historical feedback data is obtained.

The first keyword is an interest keyword of the user determined based on the historical behavior data and the historical feedback data. As described above, the first keyword may obtained by using a method including but not limited to the following: the first neural network model (input and output data are as described above and are not repeated), keyword clustering, and a correspondence between an object and the keyword.

For example, an association between the object and the keyword may be preset in advance, so that when performing this step, the keywords corresponding to respective objects involved in the historical behavior data and historical feedback data are obtained according to the association, to obtain the first keyword. Alternatively, the keywords corresponding to respective objects involved in the historical behavior data and historical feedback data are obtained according to the association, then the keywords are clustered, and the clustered keywords are determined as the first keyword.

In step S1042-4, an interest level of each of second keywords other than the first keyword in a keyword set is obtained.

In one or more embodiments of the present disclosure, the second keywords are keywords other than the first keyword, that is, the keywords that are not involved in or less involved in the historical behavior data, and it is difficult to determine the interest tendency regarding these keywords. Therefore, the interest tendency regarding these keywords may be emphasized.

The interest level may be obtained in multiple ways. In a possible design, the interest level of the second keyword may be determined as a degree of proximity between the second keyword and the first keyword set. In this case, the interest level of the second keyword may be obtained by at least one of the following manner:

Degrees of proximity between the second keyword and respective first keywords are obtained. Then, the degrees of proximity are weighted or averaged, to obtain the degree of proximity between the second keyword and the first keyword set as the interest level of the second keyword.

Alternatively, the first keyword set may be vectorized in advance. In this case, the second keywords are vectorized, and degrees of proximity between vectors of respective second keywords and the vector of the first keyword set are obtained, to obtain the interest levels of respective second keywords.

Further, in addition to obtaining the interest level of each of the second keywords, similar to the above implementation where the keywords are classified or graded, the interest level of the second keyword of a category is first calculated. If the interest level of the keyword of the category is lower than a preset degree threshold, the keyword of the category is determined as a keyword that has not been concerned by the user, and the interest level of keywords of sub-categories under the key keyword of the category may not be obtained. For example, “Sports” is a keyword of a category, and “Basketball” is a keyword of a sub-category under “Sports”. In this case, if “Sports” is of low interest and the user has not been involved in sports objects, there is no need to obtain the interest level of keywords of sub-categories such as “Basketball”. With this implementation, the amount of data to be processed in this step can be reduced to a certain extent, which is beneficial to improve processing efficiency.

In step S1042-6, the second keywords are ranked in an ascending order of the interest level, and at least one second keyword ranked highest is obtained as the questioning keyword.

For second keywords having a low interest level, the user may never be involved in objects in the field referred to by the second keywords. Therefore, at least one second keyword may be selected from the second keywords having a low interest level as the questioning keyword, and the question-and-answer interaction may be performed to determine the interest tendency of the user regarding these uncertain second keywords.

For example, in the scenario of recommending news for users, if the historical behavior data of the user does not include any records or feedback on sports news, the interest level of the keyword “Sports” obtained by the above method may be very low. In this case, “Sports” may be used as a questioning keyword to obtain the feedback data of the user regarding the keyword “Sports”, so as to better understand the interest of the user.

In addition, after the above processing, the number of second keywords with a lower interest level is still large, the second keywords with a lower interest level may be further selected considering the data volume of the question-and-answer interaction, such that the number of obtained questioning keywords is less than or equal to a specified number.

In a possible design, according to the classification relationship of the keywords, multiple second keyword groups corresponding to each category are ranked according to a descending order of classification levels, and one or more second keywords having higher classification levels are determined as questioning keywords.

For example, in the news recommendation scenario, the second keywords with a lower interest level include: “Sports”, “Finance”, “Basketball”, “Football”, and “Stock”. In this case, according to the classification level, “Sports” and “Finance” which have higher classification levels are determined as questioning keywords.

In another possible design, for each classification level of second keywords, ranking may be performed for the classification level according to the interest level, and one or more second keywords ranked highest in a level (from low to high) are determined as the questioning keyword.

For example, in the news recommendation scenario, the second keywords “Sports”, “Finance”, “Basketball”, “Football”, and “Stock” are obtained. In this case, for a first classification level, the interest level of “Sports” may be compared with the interest level of “Finance”. If “Finance” has a lower interest level, “Finance” may be used as a questioning keyword. In this case, the keyword “Stock” under “Finance” does not need to be compared and screened. In the “Sports” category, “Basketball” has a lower interest level than “Soccer”, and may also be used as a keyword for this classification level. In this way, “Finance” and “Basketball” are obtained as the keywords in this scenario.

In addition to a further screening strategy similar to the previous design, K second keywords may be randomly selected from the multiple second keywords ranked highest according to the interest level (from low to high) as questioning keywords, which is not described in detail.

In addition to performing only step S1042-6 to determine the questioning keywords, another implementation is further provided according to the one or more embodiments of the present disclosure, which includes: performing only the following step S1042-8; or, performing step S1042-6 in combination with step S1042-8 to determine the questioning keyword.

In step S1042-8, at least one second keyword ranked lowest according to an ascending order of the interest level is obtained as the questioning keyword.

This design considers that a higher interest level and a higher degree of proximity to the historical behavior data of the user indicates that the user is more likely to be interested in the object corresponding to this keyword.

The implementation of this step is similar to that of step S1042-6, and is not described in detail. In a case that step S1042-6 is performed in combination with step S1042-8, x second keywords with higher degrees of interest and y second keywords with lower degrees of interest are selected, where the sum of x and y is less than or equal to K, x and y are both integers greater than 0.

In addition to the above determining the questioning data by using the interest level, another possible implementation of step S104 is further provided according to the one or more embodiments of the present disclosure, which includes: determining the keyword of the question by prediction.

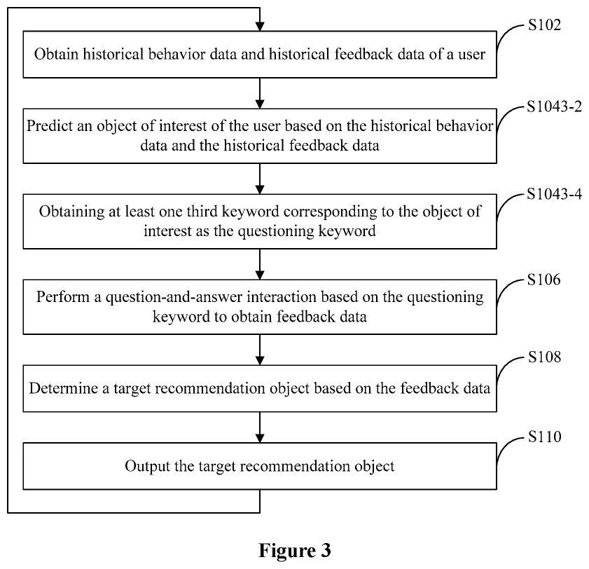

In a possible design, referring to the method shown in FIG. 3, step S104 may be implemented through the following steps S1043-2 and S1043-4.

In step S1043-2, an object of interest of the user is predicted based on the historical behavior data and the historical feedback data.

In this step, the historical behavior data and historical feedback data may be processed through a trained object prediction model, and an output of the object prediction model is the object of interest of the user. The object prediction model is not limited in the one or more embodiments of the present disclosure, and may be a convolutional neural network (CNN) model, a recurrent neural network (RNN) model, or the like. Before performing this step, an initial object prediction model is trained by using sample data to obtain a trained object prediction model. The inputted data among the sample data has the same form as the historical behavior data and the historical feedback data.

In addition, before inputting the historical behavior data and the historical feedback data into the object prediction model, pre-processing may be performed on the historical behavior data and the historical feedback data according to actual needs. The pre-processing may include one or more of: numerical processing, normalization processing, clustering processing, vectorization processing, and fusion processing, which are not limited in the one or more embodiments of the present disclosure.

In step S1043-4, at least one third keyword corresponding to the object of interest is obtained as the questioning keyword.

Based on the predicted object of interest, the third keyword corresponding to the object of interest is determined according to a mapping relationship between the object and the keyword. In addition, similar to the above implementations, due to the great number of the third keywords, a screening algorithm may also be used to determine the questioning keyword among the third keywords, or the questioning keyword may be randomly selected from the third keywords, which is not described in detail.

The implementation shown in FIG. 3 is based on the historical behavior data of the user to predict the object that the user may be interested in. When there is sufficient sample data, the object prediction model has high prediction accuracy, and the questioning keyword obtained based on the based on object prediction model conforms to the interest tendency of the user.

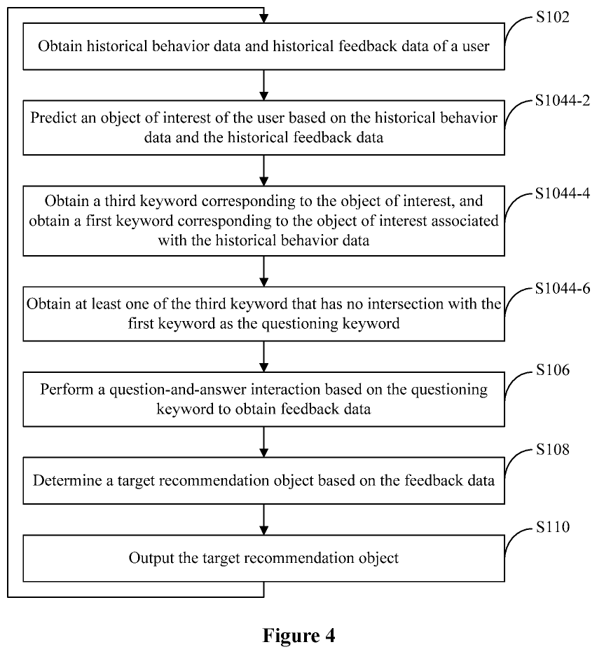

Further, in the implementation shown in FIG. 3, in addition to the processing according to step S1043-4, considering that the third keywords may overlap with some of the first keywords, there is no need to query the user by using the overlapped keywords. Therefore, the keywords without overlapping may be queried to maximize the difference between the first keywords and the third keywords. In this case, referring to FIG. 4, step S104 may be implemented through the following steps S1044-2 to S1044-6.

In step S1044-2, the object of interest of the user is predicted based on the historical behavior data and the historical feedback data.

In step S1044-4, a third keyword corresponding to the object of interest is obtained, and a first keyword corresponding to the object of interest related to the historical behavior data is obtained.

The definition of the first keyword is the same as that described above, and is not repeated here.

In step S1044-6, at least one third keyword that does not intersect the first keyword is obtained as the questioning keyword.

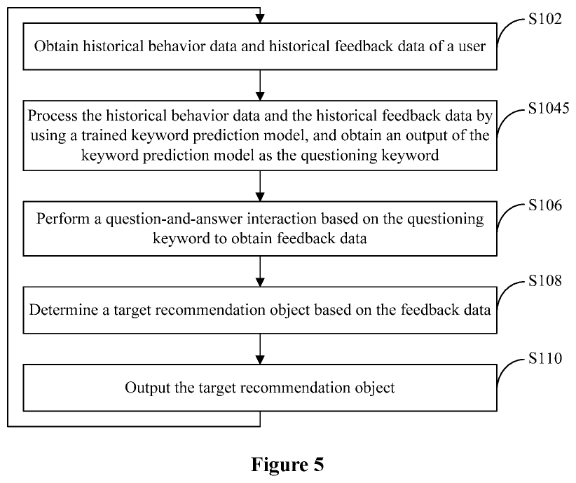

In addition to predicting the object by using the historical behavior data of the user shown in FIG. 3 or 4, the keyword may be directly predicted. In this case, referring to the method shown in FIG. 5, step S104 includes the following step S1045.

In step S1045, the historical behavior data and the historical feedback data are processed by using the trained keyword prediction model, and an output of the keyword prediction model is obtained as the questioning keyword.

The input data of the keyword prediction model is the historical behavior data and the historical feedback data of the user. Similarly, in addition to directly inputting the historical behavior data and the historical feedback data into the keyword prediction model, pre-processing may be performed on the historical behavior data and the historical feedback data before the historical behavior data and the historical feedback data are inputted into the keyword prediction model. The pre-processing may include but not limited to one or more of: numerical processing, normalization processing, clustering processing, vectorization processing, and fusion processing, which are not limited in the one or more embodiments of the present disclosure.

The output of the keyword prediction model may be trained according to actual needs. In a possible design, the keywords outputted by the keyword prediction model may be: K keywords that the user is most likely interested in. Alternatively, in another design, the keywords outputted by the keyword prediction model may be: K keywords that whether the user is currently interested in is most uncertain.

The type of the keyword prediction model is not limited in the one or more embodiments of the present disclosure, and may be a CNN model, an RNN model, or the like. Before performing this step, an initial keyword prediction model is trained by using sample data to obtain the trained keyword prediction model.

The questioning keyword may be determined by using any one of the above implementations shown in FIGS. 2-5.

In addition, in the implementations of the solution, the above question-answer interaction may be automatically performed each time a personalized recommendation or service customization is performed for the user.

For example, in a product recommendation scenario, if operation information that triggers a recommendation action is collected, the question-and-answer interaction may be implemented through any one of the above implementations to determine the product of interest for the user based on an obtained user interest profile and output related information.

In addition, a satisfaction degree of a historical recommendation object may be obtained based on the historical behavior data and the historical feedback data. If the satisfaction degree does not meet a preset satisfaction condition, the questioning keyword is determined and the question-and-answer interaction is performed by using the above method to obtain the user interest profile. If the satisfaction level meets the preset satisfaction condition, it is unnecessary to perform the question-and-answer interaction, and the recommendation object determined by using the current method may be directly output, which can simplify user operations and improve user experience.

The satisfaction degree may be obtained based on the historical behavior data and the historical feedback data in the following manner: in the historical behavior data and the historical feedback data, a characteristic value of each operation behavior performed by the user on a historical recommendation object is obtained, and the characteristic value of each operation behavior is weighted to obtain the satisfaction degree of the historical recommendation object.

The characteristic value is used to characterize at least one of the number of times the operation behavior is performed and a satisfaction tendency. The operation behaviors involved in the one or more embodiments of the present disclosure may include, but are not limited to, at least one of the following: a query behavior, a sharing behavior, a transaction behavior, a collection behavior, and an evaluation behavior.

Taking the news recommendation scenario as an example, the number of times the user views the historical recommended news, the number of times the user shares the historical recommended news, the number of times the user collects the historical recommended news, and the positive and negative data of the evaluation behavior (such as: agree or disagree) may be recorded. A counting method (the score corresponding to each operation behavior may be the same or different) may be used to to obtain the characteristic value for the historical recommended news. When obtaining the satisfaction degree of the user regarding the historical recommended news, the weighted sum (or weighted average) of the characteristic values of respective operation behaviors may be obtained based on customized weights.

After the satisfaction degree is obtained, the satisfaction degree is further compared with a preset satisfaction condition. In the one or more embodiments of the present disclosure, the satisfaction condition may be preset according to needs, may be preset as a specific satisfaction threshold, or may also be preset as the number of times the satisfaction threshold is not reached reaches a preset number threshold.

Then, if the satisfaction degree is less than or equal to the satisfaction threshold, it is determined that the satisfaction degree does not meet the preset satisfaction condition, and the above steps S104 to S108 are performed.

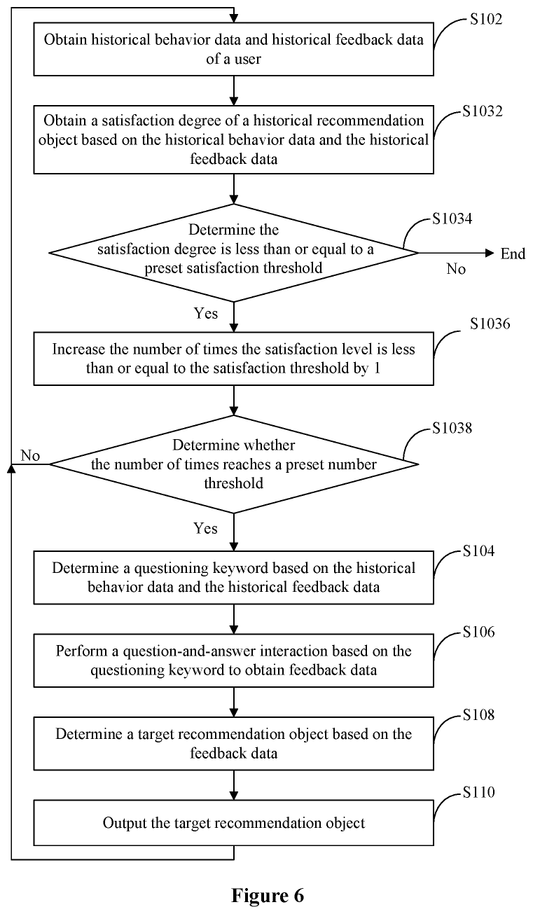

In this case, referring to FIG. 6, the method further includes the following steps S1032 to S1038 before step S104 is performed.

In step S1032, a satisfaction degree of a historical recommendation object is obtained based on the historical behavior data and the historical feedback data.

In step S1034, it is determined whether the satisfaction degree is less than or equal to a preset satisfaction threshold. If the satisfaction degree is less than or equal to a preset satisfaction threshold, step S1036 is performed. Otherwise, the process ends.

In step S1036, the number of times the satisfaction level is less than or equal to the satisfaction threshold is increased by 1.

In step S1038, it is determined whether the number of times reaches a preset number threshold. If the number to times reaches a preset number threshold, step S104 is performed. Otherwise, step S102 is performed.

Through the above solution, the number of question-and-answer interactions can be reduced to a certain extent, which is beneficial to simplify user operations and improve user friendliness.

As mentioned above, in the question-and-answer interaction scenario, the user may perform selection according to the outputted question. Therefore, the operation information of the user needs to be collected during the question-and-answer interaction. However, for a situation where the user may not want to interact or need to skip a certain question, an exit mechanism for the question-and-answer interaction is further provided according to the one or more embodiments of the present disclosure.

During the question-and-answer interaction, the operation information of the user is collected.

If the operation information indicates to cancel the question-and-answer interaction, the question-and-answer interaction is ended.

If the operation information indicates to skip a current prompt question, a next prompt question is outputted, or the question-and-answer interaction is ended, which is because the currently outputted prompt question is the last prompt question. In the latter case, if the operation information indicating cancelling is subsequently collected, the question-and-answer interaction may be ended.

The kind of information that is indicated by the operation information of the user may be preset as needed. Specifically, when performing presetting, the presetting may be implemented based on operation information of a clicking (or double-clicking) operation on a virtual key or a physical key, a sliding operation or a long-pressing operation on an outputted question output box or prompt information, and the like. If the same operation information as the preset operation information is collected, the action indicated by the preset operation information may be determined.

For example, during the question-and-answer interaction, a virtual cancel button may be outputted on the display interface, for example, “X” is displayed on the upper right corner of the question output box. If operation information of a click operation performed by the user on the cancel button is collected, it may be determined that the operation information indicates to cancel the question-and-answer interaction.

For another example, during the interactive question-and-answer interaction, if operation information of a click operation performed by the user on a physical or virtual “Back” button is collected, it may be determined that the operation information indicates to cancel the question-and-answer interaction.

For another example, multiple virtual subpages may be provided during the question-and-answer interaction, and each virtual subpage is used to ask one or more keywords. In this way, if a left or right sliding action for the virtual subpage is collected, switching between these virtual subpages is performed to switch between questions or skip a question.

Through the above implementation, the question-and-answer interaction with the user can be performed, thereby obtaining the interest keyword of the user.

In the following, the application scenario of the above user interest profile, that is the manner of determining the target recommendation object in step S108, is further explained.

The method for determining the target recommendation object based on the feedback data may include: constructing a user interest profile of the user based on the feedback data, and determining the target recommendation object based on the user interest profile.

When step S108 is implemented, the target recommendation object may be determined based only on the feedback data. Alternatively, the user interest profile may be constructed based on the feedback data and one of the historical behavior data and the historical feedback data, so as to determine the target recommendation object.

In a possible implementation, through the above question-and-answer interaction, it may be determined whether the user is interested in each questioning keyword, so that when performing this step, the interest keyword of the user indicated by the feedback data may be used as the user interest profile. In this case, the target recommendation object may be determined based on only the feedback data.

In addition, in a possible implementation scenario, an implementation for determining the target recommendation object based on the feedback data, the historical behavior data, and the historical feedback data is provided according to one or more embodiments of the present disclosure. As shown in FIG. 7, step S108 may include the following steps S1082 and S1084.

In step S1082, a user interest profile of the user is constructed based on the feedback data, the historical behavior data, and the historical feedback data.

In a possible design, if there are historical behavior data and historical feedback data, and a historical interest profile is obtained based on the historical behavior data and historical feedback data, when performing this step, the historical interest profile may be updated based on the interest keyword that is determined based on the feedback data, so as to obtain the user interest profile.

In another possible design, the historical behavior data, the historical feedback data and feedback data may be fused to obtain the user interest profile.

The user interest profile (or the historical interest profile) may be obtained based on the above data through at least the following methods.

In one implementation, the keywords of interest of the user that are respectively indicated by the feedback data and the historical feedback data may be obtained. For the historical behavior data, the keyword corresponding to the historical behavior data may be obtained by using the first neural network model, keyword clustering, or the correspondence between the object and the keyword. The keywords of interest of the user that are respectively indicated by the feedback data and the historical feedback data and the keyword corresponding to the historical behavior data are combined to obtain the user interest profile (or the historical interest profile). The input of the first neural network model is the historical behavior data, and the output of the first neural network is the interest keyword of the user. Then, the keywords of interest of the user that are respectively indicated by the feedback data and the historical feedback data and the interest keyword corresponding to the historical behavior data are fused (and may be further de-duplicated or classified) to obtain the user interest profile.

In another implementation, the historical behavior data, the historical feedback data and feedback data are fused to obtain a fused feature vector, which is further processed by using a second neural network model to obtain the user interest profile (or the historical interest profile). The input of the second neural network model is a feature vector, and the output of the second neural network model is the interest keyword of the user.

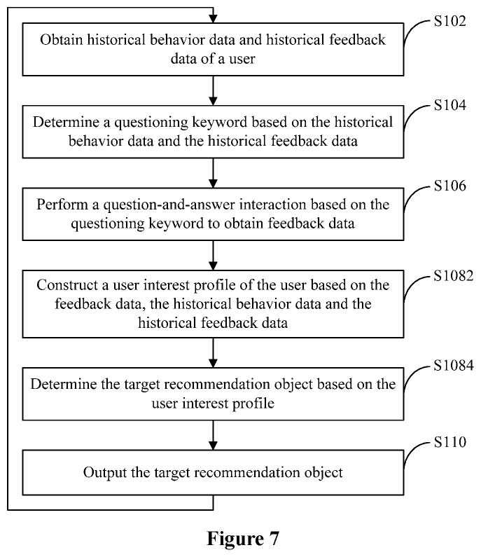

In addition, in the scenario shown in FIG. 8, the target recommendation object is determined by using the historical behavior data, the historical feedback data, and the feedback data. In an actual application, only one of the historical behavior data and the historical feedback data is combined with the feedback data to determine the target recommendation object, which is implemented in a similar manner as the above, and is not described in detail.

In S1084, the target recommendation object is determined based on the user interest profile.

As mentioned above, the user interest profile may include at least one interest keyword of the user, and each keyword may correspond to multiple objects. For example, the user interest profile may be: Sports, Finance, and Home, and “Sports” may further correspond to multiple sports news, and the others are similar. Then, when performing this step, the target recommendation object to be recommended to the user is further determined based on the user interest profile.

At least the following implementations are provided according to the one or more embodiments of the present disclosure.

In one implementation, at least one target keyword is determined based on the user interest profile, and objects are ranked according to a descending order of a matching degree between each of the objects and the at least one target keyword, and at least one of the objects ranked highest is determined as the target recommendation object.

In this implementation, at least one target keyword may be determined randomly or according to any rules. Then, for any one of the target keyword, the matching degree between the target keyword and each associated object is obtained, and the object having a higher matching degree is selected and determined as the target recommendation object.

Among them, the matching degree may be obtained in various ways. For example, the neural network algorithm may be used to identify the keyword attribute of the object, and then the matching degree between the object and each keyword may be obtained. For another example, keyword recognition is performed on the object information, and the ratio of the target keyword to all keywords in the object information is used as the matching degree.

In another implementation, the object category indicated by the user interest profile is determined, and in each object category, objects are ranked in a descending order of an evaluation value, and at least one object ranked highest is determined as the target recommendation object.

In this implementation, each interest keyword included in the user interest profile may correspond to one or more object categories. In this case, for each object category, one or more objects with higher evaluation values are separately screened out as target recommendation objects.

The evaluation value may be obtained according to a statistical rule of relevant information of the object. The dimension of the evaluation value participated in the above process is not limited in the one or more embodiments of the present disclosure. The evaluation value may be the evaluation value of the entire object, the evaluation value of the credit degree, or a favorable value, or may be the evaluation value of the viewing dimension. For example, the evaluation value of physical objects such as commodities may include but is not limited to the following: a comprehensive evaluation value, a transaction degree value (such as a total transaction value, and the like), comment data value (such as favorable rate, unfavorable rate, and the like). For information objects such as news, the evaluation value may include, but is not limited to: a view evaluation value (such as a click rate), a share evaluation value (the number of shares, and the like), and the like.

In addition to the above implementation, the target recommendation object may also be obtained through a neural network algorithm. In this case, the input data of the recommendation model is the user interest profile, and the output of the recommendation model is the predicted target recommendation object. It should be understood that some or all of the steps or operations in the above one or more embodiments are only examples, and other operations or variations of operations may be performed in the one or more embodiments of the present disclosure. In addition, the various steps may be performed in different orders presented in the above one or more embodiments, and it is possible that not all operations in the above one or more embodiments are to be performed.

When used in the present disclosure, although the terms “first”, “second”, and the like may be used to describe respective keywords, these keywords should not be limited by these terms. These terms are only used to distinguish one keyword from another. For example, without changing the meaning of the description, the first keyword may also be referred to as the second keyword, and likewise, the second keyword may also be referred to as the first keyword, as long as all occurrences of the “first keyword” are consistent, and all occurrences of the “second keyword” are consistent. Both the first keyword and the second keyword are keywords, but may not be the same keyword.

The terms used in the present disclosure are only used to describe the one or more embodiments and are not used to limit the claims. As used in the description of the one or more embodiments and claims, unless the context clearly indicates otherwise, the singular forms “a”, “an” and “said” are intended to include plural forms as well. Similarly, the term “and/or” as used in the present disclosure is meant to include any and all possible combinations of one or more associated lists. In addition, when used in the present disclosure, the term “comprise” and its variations “comprises” and/or “comprising” refer to the presence of the stated feature, entity, step, operation and/or element, and does not exclude the presence or addition of one or more other features, entities, steps, operations, elements, components, and/or groups thereof.

Those of ordinary skill in the art may understand that all or part of the steps to implement the above method embodiments may be completed by a program instructing related hardware. The above program may be stored in a computer-readable storage medium, and when the program is executed, the steps of the above method embodiments are included.

The above storage media include various media that may store program codes, such as ROM, RAM, a magnetic disk, or an optical disk.

Based on the above object recommendation method according to one or more embodiments, one or more apparatus embodiments that implement the steps and methods in the above method embodiments is further provided according to the one or more embodiments of the present disclosure.

An object recommendation apparatus is provided according to one or more embodiments of the present disclosure. Referring to FIG. 8, the object recommendation apparatus 800 includes an obtaining module 81, a first determining module 82, an interacting module 83, and a second determining module 84.

The obtaining module 81 is configured to obtain historical behavior data and historical feedback data of a user.

The first determining module 82 is configured to determine a questioning keyword based on the historical behavior data and the historical feedback data.

The interacting module 83 is configured to perform a question-and-answer interaction based on the questioning keyword to obtain feedback data.

The second determining module 84 is configured to determine a target recommendation object based on the feedback data.

The interacting module 82 is further configured to output the target recommendation object.

In a possible design, the first determining module 82 is configured to:

obtain a first keyword corresponding to the historical behavior data and the historical feedback data,

obtain an interest level of each of second keywords other than the first keyword in a keyword set,

rank the second keywords in an increasing order of the interest level, and obtain at least one second keyword that is ranked highest as the questioning keyword, and/or obtain at least one second keyword that is ranked lowest as the questioning keyword.

In another possible design, the first determining module 82 is configured to:

predict an object of interest of the user based on the historical behavior data and the historical feedback data, and

obtain at least one third keyword corresponding to the object of interest as the questioning keyword.

In another possible design, the first determining module 82 is configured to:

predict an object of interest of the user based on the historical behavior data and the historical feedback data,

obtain a third keyword corresponding to the object of interest, and obtain a first keyword corresponding to the historical behavior data and the historical feedback data, and

obtain at least one of the third keyword that has no intersection with the first keyword as the questioning keyword.

In another possible design, the first determining module 82 is configured to:

process the historical behavior data and the historical feedback data by using a trained keyword prediction model, and obtain an output of the keyword prediction model as the questioning keyword.

In another possible design, the first determining module 82 is further configured to:

obtain a satisfaction degree of a historical recommendation object based on the historical behavior data and the historical feedback data, and

determine the questioning keyword based on the historical behavior data if the satisfaction degree does not meet a preset satisfaction condition.

In this case, in an implementation, the first determining module 82 is further configured to:

obtain, in the historical behavior data and the historical feedback data, a characteristic value of each operation behavior performed by the user on the historical recommendation object, where the characteristic value characterizes at least one of the number of times the operation behavior is performed and a satisfaction tendency, and

weight the characteristic value of the operation behavior to obtain the satisfaction degree of the historical recommendation object.

In this case, in another implementation, the first determining module 82 is further configured to:

compare the satisfaction degree with a preset satisfaction threshold, and

determine that the satisfaction degree does not meet the preset satisfaction condition if the satisfaction degree is less than or equal to the satisfaction threshold, or count the number of times the satisfaction degree is less than or equal to the satisfaction threshold, and determine that the satisfaction degree does meet the preset satisfaction condition if the number of times reaches a preset number threshold.

In another possible design, the interacting module 83 is further configured to:

collect operation information of the user during the question-and-answer interaction;

end the question-and-answer interaction if the operation information indicates to cancel the question-and-answer interaction; and

output a next prompt question or end the question-and-answer interaction if the operation information indicates to skip a current prompt question.

In another possible design, the second determining module 84 is further configured to:

construct a user interest profile of the user based on the feedback data, and

determine the target recommendation object based on the user interest profile.

In another possible design, the second determining module 84 is configured to:

determine an interest keyword based on the feedback data as the user interest profile, or

determine an interest keyword based on the feedback data, and update a historical interest profile by using the interest keyword to obtain the user interest profile, where the historical interest profile is obtained based on the historical behavior data.

In an implementation, the second determining module 84 is configured to:

determine at least one target keyword based on the user interest profile,

rank objects according to a descending order of a matching degree between each of the objects and the at least one target keyword, and determine at least one of the objects ranked highest as the target recommendation object.

In another implementation, the second determining module 84 is configured to:

determine an object category indicated by the user interest profile,

rank, in the object category, objects in a descending order of an evaluation value, and determining at least one object ranked highest as the target recommendation object.

In another implementation, the second determining module 84 is configured to:

determine the target recommendation object based on the feedback data, or

determine the target recommendation object based on the feedback data and one of the historical behavior data and the historical feedback data.

In the one or more embodiments of the present disclosure, the historical behavior data includes at least one of: historical query behavior data, historical sharing behavior data, historical transaction behavior data, historical collection behavior data and historical evaluation behavior data.

The object recommendation apparatus 800 according to the one or more embodiments shown in FIG. 8 may be configured to implement the technical solutions of the above method embodiments. For the implementation principles and technical effects of the object recommendation apparatus 800, reference may be made to the related descriptions in the method embodiments. Optionally, the object recommendation apparatus 800 may be a terminal device.

It should be understood that the modules of the object recommendation apparatus 800 shown in FIG. 8 above are divided according to logical functions, and may be integrated into a physical entity as a whole or in part or may be physically separated in actual implementations. In addition, these modules may all be implemented in the form of software called by processing elements, may be implemented in the form of hardware. Alternatively, some of the modules may be implemented in the form of software called by processing elements, and some of the modules may be implemented in in the form of hardware. For example, the obtaining module 84 may be a separately established processing element, may be integrated in the object recommendation apparatus 800, for example, implemented in a chip of a terminal, or may also be stored in the memory of the object recommendation apparatus 800 in the form of a program, which is called and executed by a certain processing element of the object recommendation apparatus 800 to implement the functions of the above modules. The implementation of other modules is similar. In addition, all or part of these modules may be integrated together or may be implemented independently. The processing element described here may be an integrated circuit with signal processing capabilities. In an implementation process, steps of the above method or the above modules may be implemented by an integrated logic circuit of hardware in the processor element or instructions in the form of software.

For example, the above modules may be one or more integrated circuits configured to implement the above method, for example: one or more Application Specific Integrated Circuits (ASIC), one or more Digital Signal Processors (DSP), one or more Field

Programmable Gate Arrays (FPGA), or the like. As another example, when a certain module above is implemented in the form of a processing element scheduling a program, the processing element may be a general-purpose processor, such as a Central Processing Unit (CPU) or other processors that capable of calling a program. As another example, these modules may be integrated together and implemented in the form of a System-On-a-Chip (SOC).

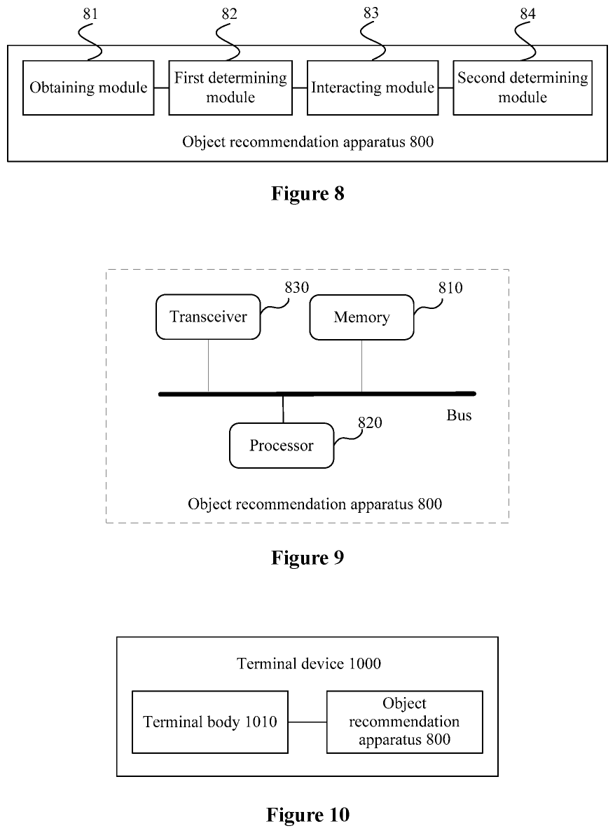

Further, an object recommendation apparatus is provided according to one or more embodiments of the present disclosure. Referring to FIG. 9, the object recommendation apparatus 800 includes:

a memory 810,

a processor 820, and

a computer program.

The computer program is stored in the memory 810 and is configured to be executed by the processor 820 to implement the method as described in the above embodiments.

The number of processors 820 in the object recommendation apparatus 800 may be one or more, and the processor 820 may also be referred to as a processing unit, which may implement a control function. The processor 820 may be a general-purpose processor or a dedicated processor. In an alternative design, the processor 820 may also store instructions, and the instructions may be executed by the processor 820, so that the object recommendation apparatus 800 executes the method described in the above method embodiments.

In another possible design, the object recommendation apparatus 800 may include a circuit, which may implement the function of sending or receiving or communicating in the above method embodiment.

Optionally, the number of memories 810 in the object recommendation apparatus 800 may be one or more, the memory 810 stores instructions or intermediate data, and the instructions may be executed on the processor 820, so that the object recommendation apparatus 800 executes the method described in the above method embodiments. Optionally, the memory 810 may also store other related data. Optionally, instructions and/or data may also be stored in the processor 820. The processor 820 and the memory 810 may be provided separately or integrated together.

In addition, as shown in FIG. 9, a transceiver 830 is further provided in the object recommendation apparatus 800, where the transceiver 830 may be referred to as a transceiving unit, a transceiving machine, a transceiving circuit, or a transceiver, and the like, and is configured to transmit data or communication with a test device or other terminal devices, which is not described in detail here.

As shown in FIG. 9, the memory 810, the processor 820, and the transceiver 830 are connected and communicate with each other through a bus.

If the object recommendation apparatus 800 is used to implement the method corresponding to FIG. 1, for example, the question-and-answer interaction with the user may be implemented through the transceiver 830. The processor 820 is used to implement a corresponding determination or control operation. Optionally, a corresponding instruction may be stored in the memory 810. For the specific processing method of each component, reference may be made to the related description of the above embodiments.

In addition, a readable storage medium on which a computer program is stored is provided according to one or more embodiments of the present disclosure. The computer program is executed by a processor to implement the method as described one or more embodiments.

Further, a terminal device is provided according to one or more embodiments of the present disclosure. Referring to FIG. 10, the terminal device 1000 includes:

a terminal body 1010, and

an object recommendation apparatus 800 configured to execute the method described in one or more embodiments.

The terminal device involved in the one or more embodiments of the present disclosure may be a wireless terminal or a wired terminal. A wireless terminal may be a device that provides voice and/or other service data connectivity to a user, a handheld device with a wireless connection function, or other processing device connected to a wireless modem. A wireless terminal may communicate with one or more core network devices via a Radio Access Network (abbreviated as RAN). The wireless terminal may be a mobile terminal, such as a mobile phone (or “cellular” phone) or a computer having a mobile terminal, such as a portable, pocket-sized, hand-held, computer built-in or vehicle-mounted mobile device that exchanges language and/or data with the wireless access network. For another example, the wireless terminal may also be a Personal Communication Service (PCS) phone, a cordless phone, a Session Initiation Protocol (SIP) phone, a Wireless Local Loop (WLL) station, a Personal Digital Assistant (abbreviated as PDA), and the like. The wireless terminal may also be referred to as a system, a subscriber unit, a subscriber station, a mobile station, a mobile, a remote station, a remote terminal, an access terminal, a user terminal, a user agent, a user device or user equipment, which is not limited here. Optionally, the terminal device may also be a smart watch, a tablet computer, and the like.

Since the modules in this embodiment are capable of executing the method shown in the first embodiment, for the parts not described in detail in this embodiment, reference may be made to the relevant description of the method embodiments.

Finally, it should be noted that the above one or more embodiments are used to illustrate rather than limit the technical solutions of the present disclosure. Although the present disclosure is described in detail with reference to the above one or more embodiments, those of ordinary skill in the art should understand that: the technical solutions described in the above one or more embodiments may still be modified, or some or all of the technical features thereof may be equivalently replaced; and these modifications or replacements do not cause the essence of the technical solutions to deviate from scope of the corresponding technical solutions of one or more embodiments of the present disclosure.

1. An object recommendation method, comprising:
obtaining historical behavior data and historical feedback data of a user;
determining a questioning keyword based on the historical behavior data and the historical feedback data;
performing a question-and-answer interaction based on the questioning keyword to obtain feedback data;
determining a target recommendation object based on the feedback data; and
outputting the target recommendation object.

2. The method according to claim 1, wherein the determining the questioning keyword based on the historical behavior data and the historical feedback data comprises:
obtaining a first keyword corresponding to the historical behavior data and the historical feedback data,
obtaining an interest level of each of second keywords other than the first keyword in a keyword set,
ranking the second keywords in an ascending order of the interest level, and obtaining at least one second keyword ranked highest as the questioning keyword, and/or obtaining at least one second keyword that is ranked lowest as the questioning keyword.

3. The method according to claim 1, wherein the determining the questioning keyword based on the historical behavior data and the historical feedback data comprises:
predicting an object of interest of the user based on the historical behavior data and the historical feedback data, and
obtaining at least one third keyword corresponding to the object of interest as the questioning keyword.

4. The method according to claim 1, wherein the determining the questioning keyword based on the historical behavior data and the historical feedback data comprises:
predicting an object of interest of the user based on the historical behavior data and the historical feedback data,
obtaining a third keyword corresponding to the object of interest, and obtaining a first keyword corresponding to the historical behavior data and the historical feedback data, and
obtaining at least one of the third keyword that has no intersection with the first keyword as the questioning keyword.

5. The method according to claim 1, wherein the determining the questioning keyword based on the historical behavior data and the historical feedback data comprises:
processing the historical behavior data and the historical feedback data by using a trained keyword prediction model, and obtaining an output of the keyword prediction model as the questioning keyword.

6. The method according to claim 1, wherein the determining the questioning keyword based on the historical behavior data and the historical feedback data comprises:
obtaining a satisfaction degree of a historical recommendation object based on the historical behavior data and the historical feedback data, and
determining the questioning keyword based on the historical behavior data and the historical feedback data if the satisfaction degree does not meet a preset satisfaction condition.

7. The method according to claim 6, wherein the obtaining the satisfaction degree of the historical recommendation object based on the historical behavior data and the historical feedback data comprises:
obtaining, in the historical behavior data and the historical feedback data, a characteristic value of each operation behavior performed by the user on the historical recommendation object, wherein the characteristic value characterizes at least one of the number of times the operation behavior is performed and a satisfaction tendency, and
weighting the characteristic value of the operation behavior to obtain the satisfaction degree of the historical recommendation object.

8. The method of claim 6, further comprising:
comparing the satisfaction degree with a preset satisfaction threshold, and
determining that the satisfaction degree does not meet the preset satisfaction condition if the satisfaction degree is less than or equal to the satisfaction threshold, or counting the number of times the satisfaction degree is less than or equal to the satisfaction threshold, and determining that the satisfaction degree does meet the preset satisfaction condition if the number of times reaches a preset number threshold.

9. The method according to claim 1, further comprising:
collecting operation information of the user during the question-and-answer interaction;
ending the question-and-answer interaction if the operation information indicates to cancel the question-and-answer interaction; and
outputting a next prompt question or ending the question-and-answer interaction if the operation information indicates to skip a current prompt question.

10. The method according to claim 1, wherein the determining the target recommendation object based on the feedback data comprises:
constructing a user interest profile of the user based on the feedback data, and
determining the target recommendation object based on the user interest profile.

11. The method according to claim 10, wherein the constructing the user interest profile of the user based on the feedback data comprises:
determining an interest keyword of the user based on the feedback data as the user interest profile, or
determining an interest keyword of the user based on the feedback data, and updating a historical interest profile by using the interest keyword to obtain the user interest profile, wherein the historical interest profile is obtained based on the historical behavior data.

12. The method according to claim 10, wherein the determining the target recommendation object based on the user interest profile comprises:
determining at least one target keyword based on the user interest profile,
ranking objects according to a descending order of a matching degree between each of the objects and the at least one target keyword, and determining at least one of the objects ranked highest as the target recommendation object.

13. The method according to claim 10, wherein the determining the target recommendation object based on the user interest profile comprises:
determining an object category indicated by the user interest profile,
ranking, in the object category, objects in a descending order of an evaluation value, and determining at least one object ranked highest as the target recommendation object.

14. The method according to claim 1, wherein the historical behavior data comprises at least one of: historical query behavior data, historical sharing behavior data, historical transaction behavior data, historical collection behavior data and historical evaluation behavior data.

15. The method according to claim 1, wherein the determining the target recommendation object based on the feedback data comprises:
determine the target recommendation target based on the feedback data, or determining the target recommendation object based on the feedback data and one of the historical behavior data and the historical feedback data.

16. An object recommendation apparatus, comprising:
a memory;
a processor; and
a computer program,
wherein the memory stores the computer program, and the computer program, when executed by the processor, cause the processor to:
obtain historical behavior data and historical feedback data of a user;
determine a questioning keyword based on the historical behavior data and the historical feedback data;
perform a question-and-answer interaction based on the questioning keyword to obtain feedback data; and
determine a target recommendation object based on the feedback data, wherein
output the target recommendation object.

17. (canceled)

18. A computer-readable storage medium, having a computer program stored thereon, wherein
the computer program is executed by a processor to perform operations, the operations comprising:
obtaining historical behavior data and historical feedback data of a user;
determining a questioning keyword based on the historical behavior data and the historical feedback data;
performing a question-and-answer interaction based on the questioning keyword to obtain feedback data;
determining a target recommendation object based on the feedback data; and
outputting the target recommendation object.

19. (canceled)
